(19) United States
(12) Patent Application Publication
(10) Pub. No.: US 2006/0143135 A1
(43) Pub. Date: Jun. 29, 2006

(54) Associating licensing information with software applications

(76) Inventors: David Maxwell Tucker, Parkinson (AU); Brook Christopher Lewis, Carindale (AU); Adam Hubert Zielinski, Upper Mt Gravatt (AU)

Correspondence Address: FENWICK & WEST LLP;SILICON VALLEY CENTER, 801 CALIFORNIA STREET, MOUNTAIN VIEW, CA, 94041, US

(21) Appl. No.: 11/286,258

(22) Filed: Nov. 23, 2005

(30) Foreign Application Priority Data
Nov. 26, 2004 (AU) 2004906740

(51) Int. Cl. H04L 9/00

(52) U.S. Cl. 705/59

(57) ABSTRACT

A license control module manages the downloading of a software application so the software application can be executed without requiring a separate activation key. In addition, the license control module can incorporate into the software application vendor-defined user customization information to customize the software application. A client computer makes a request to download a software application, and the request is received by a server. The server incorporates licensing information into a download manager to generate a customized download manager that is specific to the download request and that is downloaded by and delivered to the client. The client executes the customized download manager, which in turn downloads the software application and associates the licensing information with the software application, altering the functionality of the application upon execution (e.g., allows it to operate or customizes it to the user, etc.).

### RELATED APPLICATIONS

This application claims the benefit of Australian Provisional Application No. 2004906740, filed on Nov. 26, 2004, entitled “Download Manager Application,” filed under the authority of IP Australia, a federal government agency within the Australian Government, located in Australia at Discovery House, 47 Bowes Street, Phillip ACT, 2606 (P.O. box 200, Woden ACT 2606), the entire disclosure of which is hereby incorporated by reference herein in its entirety for all purposes. The basis for priority is Australia's participation and membership under the following: The Paris Convention for the Protection of Industrial Property and the World Trade Organization.

### BACKGROUND OF THE INVENTION

1. Field of the Invention

This invention pertains in general to downloading of software over the Internet or other network, and more specifically to managing the downloading of a software application and associating the application with software licensing information.

2. Description of the Related Art

Software applications are commonly purchased over the Internet and downloaded onto a user's computer for use in performing a defined task or function. After the software application has been purchased, the purchaser can download the application over the Internet using transfer protocols such as the File Transfer Protocol (FTP) and the Hypertext Transfer Protocol (HTTP). To activate or unlock the downloaded application so that the user can execute the application on the computer, an activation key provided by the vendor is commonly required. This activation key is typically sent to the user within a separate e-mail message to the user's e-mail address or otherwise provided in some manner in which the activation key is delivered separate from the software application itself. When trying to run the downloaded application, the user can then insert the activation key where necessary or when prompted, and the user can then run the application.

Problems in this activation process arise when the activation key is sent to a different computer (e.g., via an e-mail message) than the one to which the software application has been downloaded and installed. The computer with the installed software application cannot run the application without first activating the application, but the activation key (or relevant license information) is remotely located and/or inaccessible. If the user wishes to run the software application on a different computer than the one on which the application was purchased and to which the activation information was sent, the user will need to independently locate the activation key and forward it to the different computer (the computer on which the application will be executed). Thus, the user must manually intervene, locate the activation key, and use it to activate the software application. This activation key retrieval step results in extra time spent and extra hassle for the user before the user is actually able to use the application purchased.

Therefore, there is a need in the art for a solution that associates the activation or licensing information with the purchased software application itself, so the user does not independently have to keep track of an activation key that can easily be lost or difficult to retrieve.

### DISCLOSURE OF INVENTION

The above need is met by a license control module that manages downloading of a software application and associates the application with software licensing information. In one embodiment (e.g., on the server side), a receiving module receives a request to download the software application, and an incorporation module incorporates licensing information into a download manager to generate a customized download manager that is specific to the download request. A download manager delivery module provides the customized download manager to the computer, and the customized download manager is executed on the computer. The customized download manager in turn downloads the software application onto the computer and associates the licensing information with the software application, which alters functionality of the software application when executed

In another embodiment of the invention, a license control module downloads a software application that can then be associated with software licensing information (e.g., on the client side). A request module makes a request to download a software application from a vendor, and a download module downloads a customized download manager. A download manager execution module executes the customized download manager on the computer, which downloads the software application and associates the licensing information with the software application. A software application execution module executes the software application, and the licensing information associated with the software application alters functionality of the executed software application.

The customized download manager can associate the licensing information with the software application by modifying the software application to insert the licensing information into the application, by placing the licensing information in a registry, and so forth. In some embodiments, the licensing information is an activation key and the licensing information alters the functionality of the executed software application by permitting the software application to operate. In some embodiments, the licensing information is user-customization information and the licensing information alters the functionality of the executed software application by customizing a user interface for the software application. The software application can be executed on a computer that is the same as or different from the computer on which the customized download manager is executed.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a high-level block diagram illustrating an example of a standard computing environment 100, according to one embodiment of the present invention.

FIG. 2 is a high-level block diagram illustrating a standard computer system 200 for use with the present invention.

FIG. 3A is a high-level block diagram illustrating the functional modules within the license control module 140 on the server, according to an embodiment of the present invention.

FIG. 3B is a high-level block diagram illustrating the functional modules within the license control module 120 on the client computer, according to an embodiment of the present invention.

FIG. 4A is an illustration of a dialog box associated with the user interface for the download manager, according to an embodiment of the present invention.

FIG. 4B is an illustration of the dialog box of FIG. 4A showing proxy settings information, according to an embodiment of the present invention.

FIG. 4C is an illustration of a final dialog box associated with the user interface for the download manager, according to an embodiment of the present invention.

FIG. 5 is a flowchart illustrating steps performed to customize and deliver a download manager to the client computer, according to an embodiment of the present invention.

FIG. 6 is a flowchart illustrating steps performed to download from a server a customized download manager that associates licensing information with the software application and to execute the application, according to an embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

The license control module downloads a download manager, an application that facilitates the downloading of a software application for performing a defined task or function. The vendor can define particular licensing information that the vendor would like to be incorporated into the software application (e.g., activation key, transaction ID, user-customization information, etc.). This vendor-specified information can be incorporated into the download manager at the time it is being downloaded from the host software application server. The download manager can be linked to the software application so that when the download manager is executed, it downloads or permits the downloading of the software application. The download manager can associate or the licensing information (e.g., some or all of the licensing information incorporated into the download manager) with the software application or “wrap” the software application with the licensing information during or after the software application has been downloaded. Thus, the software vendor can specify arbitrary information to be passed on to the software application by “wrapping” extra executable functionality onto the downloaded software application.

As used herein, the term “licensing information” can include any type of information associated with a transaction or purchase of a software application, such as personal information for the user (e.g., the user's name, address, phone number, country of residence, etc.), purchase information (e.g., credit card information, cost, etc.), identification information (e.g., information identifying the particular computer on which the software application will be executed), transaction ID, Internet Service Provider identification information, activation or product key information, user preferences or user customization information, etc, or a collection of one or more of these. The term “purchase” can include any type of purchase or obtaining of a software application from a vendor, where the user may pay a certain amount of money for the software application or where the user may obtain the software application without paying any money (e.g., a non-purchased application, such as “trialware,” where a user downloads a trial version of a software application. The term “user” is not limited to human users, but can also include other non-human entities, such as software agents, etc.

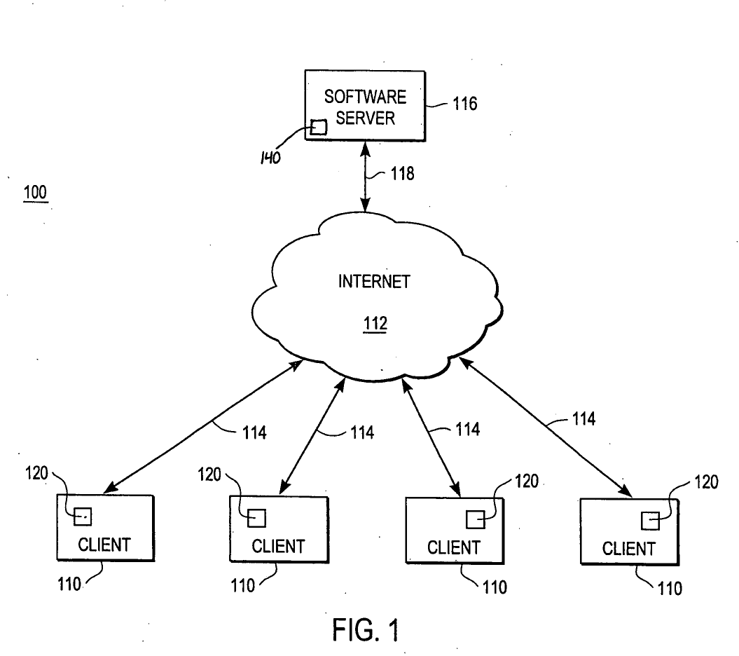

FIG. 1 is a high-level block diagram illustrating a computing environment 100 according to an embodiment of the present invention. Multiple client computers 110 are in communication with the Internet 112 or other network, such as a local area network, wide area network, etc. via communications links 114. Although only four client computers 110 are shown in FIG. 1, there can be thousands or even millions of computer systems coupled to the Internet 112, according to embodiments of the present invention. In one embodiment, the client computers 110 are conventional computer systems. In other embodiments, one or more of the client computers 110 are different electronic devices having connectivity to remote update sources, such as cellular telephones, personal digital assistants (PDAs), etc. A server 116 is also connected to the Internet 112 via a communications link 118.

As is known in the art, the client computers 110 preferably execute an operating system and one or more application programs. The operating system controls the operation of the computer system, and some examples of such an operating system include LINUX®, one of the versions of MICROSOFT WINDOWS®, and PALM OS®.

In FIG. 1, each client computer 110 is connected to the Internet 112 via a communications link 114. Preferably, the communications link 114 utilizes conventional networking technology. For example, in one embodiment a client computer 110 uses a modem to connect over standard telephone lines with an Internet Service Provider (ISP) having a high-speed connection to the Internet 112. In another embodiment, a client computer 110 uses a digital subscriber line (DSL) or cable modem to access the ISP via a telephone line or cable television line, respectively. In yet another embodiment, the client computer 110 uses a network card and Ethernet connection to directly connect to the Internet 112. In still other embodiments, the communications link 114 connects the client computer 110 via a wireless 802.11, Bluetooth, or mobile phone (e.g., CDMA or GSM) network, satellite downlink, uplink, or bi-directional link, etc. Thus, many different types of technology can be used to provide the functionality of the communications link 114.

As known in the art, the Internet is a large, publicly-accessible network of networks. Individual computers and other devices can utilize communications protocols such as the transmission control protocol/Internet protocol (TCP/IP) to send messages to other computers on the Internet. These messages can use protocols such as the hypertext transport protocol (HTTP), file transfer protocol (FTP), simple mail transport protocol (SMTP), post office protocol 3 (POP3), and Internet message access protocol (IMAP), and data representations such as the hypertext markup language (HTML) and extensible markup language (XML) to carry and exchange information. Embodiments of the present invention may use other communications protocols and languages to exchange data.

Another communications link 118 connects the server 116 to the Internet 112. The server 116 can send information across the Internet 112 and to the client computers 110 or information can be retrieved or downloaded from the server 116. For example, a software application can be purchased on and downloaded from the server 116 onto a client computer 110. Additionally, the client computers 110 can send out information (e.g., financial or credit card information and other personal information for purchasing a software application) or make requests across the Internet 112 to the server 116 or to other computers 110. The communications link 118 is generally the same as the communications links 114 connecting the client computers 110 to the Internet 112. Although only one server 116 and associated communications link 118 are shown in FIG. 1, embodiments of the present invention may have multiple servers and/or links. The server 116 may be a conventional computer system or a network of systems.

In the embodiment illustrated in FIG. 1, the server 116 executes a license control module 140 for receiving a download request from one or more client computers 110, and creating and delivering a customized download manager to the client(s) 110. Also in the embodiment illustrated in FIG. 1, each client computer 110 executes a license control module 120 for downloading of a customized download manager that downloads a software application and associates the application with software licensing information. The license control modules 120, 140 can both be a part of one system for managing downloading of a software application, or the modules 120, 140 can be two separate system or parts of a system. The modules 120, 140 can be discrete application programs, or the modules 120, 140 can be integrated into another application program(s) or the client computer's 110 operating system or other location. As shown in FIG. 1, a portion of the license control module can be executed on the server 116 as license control module 140, while a portion is executed on the client 110 as license control module 120. Other modifications can be made to accommodate any of the other numerous embodiments of the license control modules 120, 140.

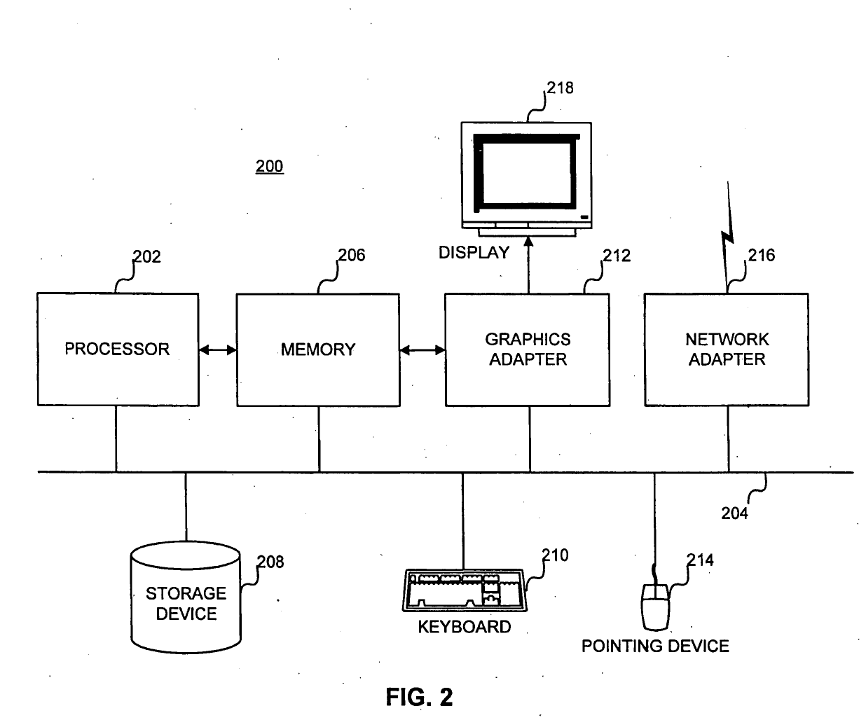

FIG. 2 is a high-level block diagram illustrating a functional view of a typical computer system 200 for storing and executing the license control module 120, according to one embodiment of the present invention. This computer system 200 can act as a client computer 110 or as a server 116, as shown in FIG. 1. However, one or more of the components of the computer system 200 may be missing or modified in the client computer 110 and/or server 116. Illustrated is a processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86, SUN MICROSYSTEMS SPARC, or POWERPC compatible-CPU, or the processor 202 may also be a custom-built processor. The memory 206 may be, for example, firmware, read-only memory (ROM), non-volatile random access memory (NVRAM), and/or RAM, and holds instructions and data used by the processor 202. The storage device 208 is, in one embodiment, a hard disk drive but can also be any other device capable of storing data, such as a writeable compact disk (CD) or DVD, and/or a solid-state memory device. The pointing device 214 may be a mouse, track ball, or other type of pointing device, and is used in combination with the keyboard 210 to input data into the computer system 200. The graphics adapter 212 displays images and other information on the display 218. The network adapter 216 couples the client computer 110 with the Internet 112.

As is known in the art, the computer system 200 and/or server 116 are adapted to execute computer program modules for providing functionality described herein. In this description, the term “module” refers to computer program logic for providing the specified functionality. A module can be implemented in hardware, firmware, and/or software. Where the any of the modules described herein are implemented as software, the module can be implemented as a standalone program, but can also be implemented in other ways, for example as part of a larger program, as a plurality of separate programs, or as one or more statically or dynamically linked libraries. It will be understood that the modules described herein represent one embodiment of the present invention. Certain embodiments may include other modules. In addition, the embodiments may lack modules described herein and/or distribute the described functionality among the modules in a different manner. Additionally, the functionalities attributed to more than one module can be incorporated into a single module. In one embodiment of the present invention, the modules are stored on the storage device 208, loaded into the memory 206, and executed by the processor 202. Alternatively, hardware or software modules may be stored elsewhere within the computer system 200.

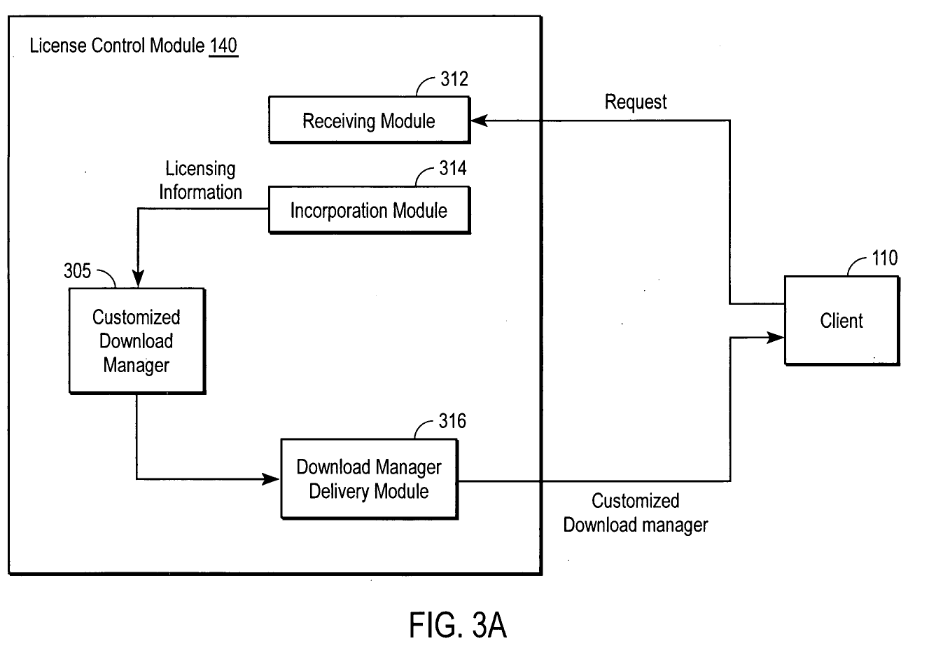

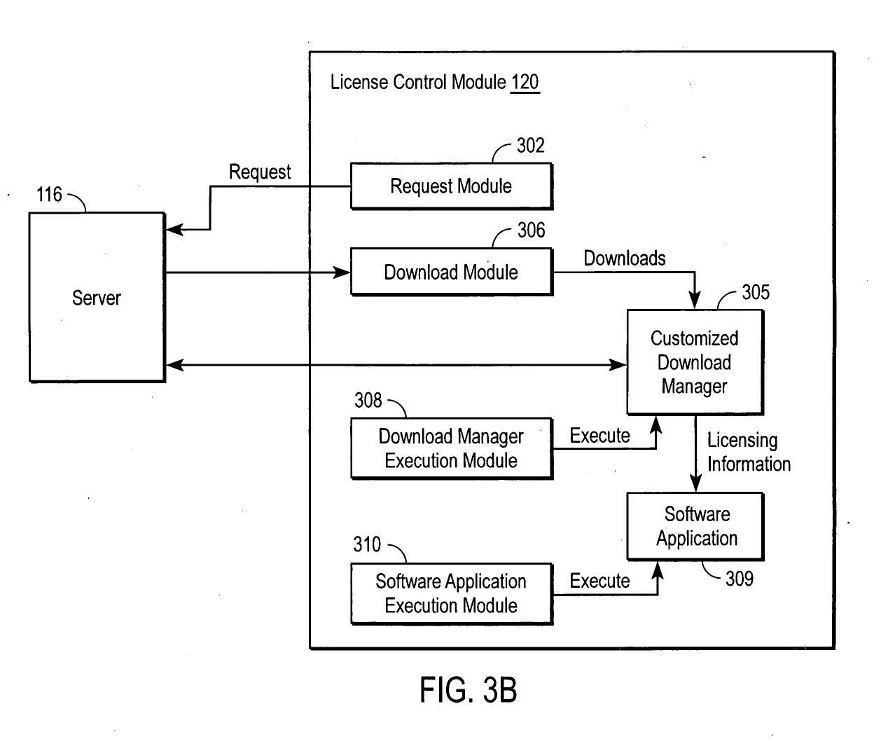

Referring now to FIGS. 3A and 3B, there is shown the license control modules 120, 140, according to an embodiment of the present invention. FIG. 3A is a high-level block diagram illustrating the functional modules within the license control module 140 that is executed on the server 116 and FIG. 3B is a high-level block diagram illustrating the functional modules within the license control module 120 that is executed on the client computer 110, according to some embodiments of the present invention. FIGS. 3A and 3B also show some entities that are not necessarily part of the licensing control module 120 (e.g., FIG. 3A shows the client 110 and FIG. 3B shows the server 116, and both show the software application 309). The license control module 140 executed on the server, in the embodiment illustrated in FIG. 3A, includes a receiving module 312, an incorporation module 314, and a download manager delivery module 316. The license control module 120 executed on the client 120, in the embodiment illustrated in FIG. 3B, includes a request module 302, a download module 306, a download manager execution module 308, and a software application execution module 310. Those of skill in the art will recognize that other embodiments can have different and/or additional modules than those shown in FIGS. 3A and 3B, and the other figures. Likewise, the functionalities can be distributed among the modules in a manner different than described herein.

Referring first to FIG. 3A, a receiving module 312 receives a request (e.g., from the client computer 110) to download the software application. For example, a user might choose to purchase a piece of software online. The user can contact the server 116 to access the software vendor's website to purchase and download the software application 309 of interest. The module 312 receives this request from the user and can prompt the user for the appropriate payment information (if the user is paying money to purchase the application 309, rather than downloading a free software application, such as a trial software application), personal information, information regarding the computer 110 onto which the software application 309 will be downloaded and executed, and so forth. The user can insert into the appropriate fields on the vendor's website these various different types of information. This information can be verified by the software vendor before the purchase is completed.

The incorporation module 314 incorporates the licensing information into a download manager to generate a customized download manager 305 that is specific to the download request. Rather than being a generic download manager for downloading software applications, the download manager 305 is customized to be specific to the particular purchase made by the user. In some embodiments, the vendor provides the licensing information to be embedded into the download manager to customize it. Thus, the vendor can specifically define what information the vendor would like included in the download manager. For example, the incorporation module 314 can prompt the vendor for information at the appropriate time and the vendor can respond by entering into the fields on the prompt (or by clicking checkboxes, clicking buttons, etc.) the information that the vendor would like embedded in the download manager. In some embodiments, the vendor defines the licensing information at the time of the purchase. In some embodiments, the vendor defines the licensing information in advance. For example, the vendor can define the information before a particular purchase, or the vendor can define information in advance of any purchases, such that the same licensing information designated by the vendor can be applied to all purchases of a particular software application or a subset of purchases (e.g., all purchases by users in a certain country, etc.). In some embodiments, some information is also obtained from the user upon purchase of the software application (e.g., the user's name, purchase information, etc.) and the vendor can choose to apply this user information in customizing the download manager.

The incorporation module 314 can incorporate into the download manager 305 numerous different kinds of information. In some embodiments, the vendor provides information that can be used as an activation key for unlocking or activating the software application 309. For example, the information to be used as the activation key might be a particular identification number designated by the vendor, such as an ID for the transaction or purchase, an ID for the user, an ID for the application 309, a combination of ID numbers, and so forth. As another example, where a user is downloading trial software, the vendor can insert licensing information that is e-commerce branding information, which provides a link to where the user can purchase a complete copy of the application. As still another example, language strings included in the download manager can be modified or rewritten as the customized download manager 305 is being downloaded (downloading step described below), depending on what language (e.g., English, Spanish, German, etc.) was requested from the server 116. For example, if a request is made to the server 116 for a software application 309 in English, this information can be passed to the download manager when creating a customized download manager 305 (e.g., in the form of an identifier for the particular language requested or in some other form). In this example, the download manager can be customized by having English words (or other language) patched into it while it is being downloaded. Thus, in this example, a user interface for the customized download manager 305 (e.g., stop or start buttons, etc.) would appear to the user in English or in another requested language. The vendor can also provide user-customization information for customizing the software application to the user. As some examples, the download manager 305 can incorporate information about the user's name, address, country of residence, information about the computer on which the application 309 will be executed, payment and/or credit card information, and other licensing information, as designated by the vendor.

The information provided can be inserted into a generic download manager as the user is downloading it from the vendor's website, so the download manager that the user ultimately receives is a vendor-customized download manager 305 with embedded licensing information. Thus, the download manager 305 is customized before or during download to be specific to the software purchase, so a second purchase by second user would involve customization to create another download manager 305 specific to the second purchase. In some embodiments, the download manager 305 is designed to be delivered in a high volume using a minimum of bandwidth, thus making deliver of the customized download manager 305 to the client 110 more quick and efficient.

The download manager delivery module 316 provides the customized download manager 305 to the computer 110. Thus, the client computer 110 is provided with a customized download manager 305 in response to its request to download a software application 309, and this download manager 305 can in turn download the software application 309 from the vendor's website. The download manager 305 associates the software application 309 with licensing information once the application 309 has been downloaded, or during the download process. The downloading of the software application and association with the licensing information is described in more detail below in reference to FIG. 3B.

Referring now to FIG. 3B, a request module 302 makes a request to download a software application 309 from a vendor. As described above, a user can access a software vendor's website to download a software application 309. The user can click on a link or button for downloading the software application 309 or otherwise make a request to the vendor. As described above, the user can be prompted for information that the user can insert in the appropriate location to make a purchase.

A download module 306 downloads the customized download manager onto a computer 110. The customized download manager 305 incorporates licensing information provided by the vendor that is specific to the download request. After the user's payment details have been verified by the software vendor upon purchase of a software application 309, the user may receive a link or some other mechanism for beginning the download. The user can click on this link to initiate download of the customized download manager 305 that incorporates licensing information. In response, the module 306 can download the download manager 305 onto the computer 110. As described above, the vendor has embedded licensing information into the download manager to generate a customized download manager 305 for the user to download. In some embodiments, the vendor can also embed information regarding the method for the download manager 305 to use in communicating the licensing information to the purchased application 309 (e.g., writing the information directly into the application 309 during or after download, writing the information to a known registry location, etc.). The download manager can then apply this method when associating the application 309 with the licensing information.

A download manager execution module 308 executes the customized download manager 305 on the computer 110 once it has been downloaded. In some embodiments, the user initiates execution (e.g., by clicking on a download manager 305 icon). In other embodiments, the download manager 305 is designed to execute automatically after it is downloaded. For example, when creating the download manager 305, the vendor can specify that the download manager 305 auto-start the download process instead of waiting for the user click on a start button, or otherwise initiate the process. If this option is enabled, a graphical user interface (“GUI”) for the download manager can begin the download process as soon as the download manager 305 is executed. If a connection to the download server is unsuccessful due to the user not being connected to the Internet at the time, or not having a proxy server specified (e.g., in the user's Internet browser settings), a warning message box can be displayed to the user. The GUI can continue to be so that the user can either establish a connection to the Internet 112, or the user can specify the proxy server, etc.

As described above, once downloaded onto the computer 10 and executed, the customized download manager 305 then downloads the software application 309 (e.g., the actual application 309 that the user purchased) onto the computer 110 and associates the licensing information with the software application 309. The download manager 305 is designed to attach licensing information (e.g., a small binary delivery of license information) to the downloaded software application 309. In some embodiments, the customized download manager 305 transfers some or all of the licensing information incorporated in the download manager 305 over to the software application 309 to wrap the software application 309. The license information can be attached to or associated with the software application 309 during the downloading of the software application 309 or after the download is complete. After the download manager 305 wraps the downloaded software application 309 with the license information, the information can stay with the application 309.

As described above, a number of different types of information can be incorporated into the download manager 305 and thus passed on to the software application 309. For example, the licensing information can include activation key information and other types of licensing information that allows the application to automatically run without manual intervention by the user. In this example, when the user tries to execute the software application 309 and the application 309 would normally prompt the user for an activation key, the application 309 can instead retrieve the activation key embedded within it or retrieve it from a registry and use this to unlock itself without bothering the user.

In other embodiments, the licensing information includes specific vendor-defined parameters for customizing the application 309 to the user (e.g., user-specific information, a serial number for the software application 309, purchase information, and the like). For example, one parameter attached to the software application 309 may include the user's name “John Smith.” When the user then begins the installation of the software application 309, this customized, vendor-defined data may (or may not) be used. The vendor might specify that the installation screen for purchaser “John Smith” have a custom message with the phrase “Hello John Smith.” As another example, the installation screen may be laid out specific to the users' country or otherwise be personalized to the user as specified by the vendor in the vendor-defined parameters. The purchased software application 309, however, is typically downloaded from a standard web server which has no knowledge of this vendor specific information.

There are numerous ways in which this licensing information can be passed on to the software application 309. For example, the download manager 305 can modify the software application 309 itself to insert the information into the application 309 (e.g., modify the binary file), place the information in a registry or directory which can be accessed by the software application 309, store or bundle the information into a file (e.g., a .zip file) that is associated with the application 309, and the like. In addition, the download manager 305 can use a combination of these methods. In some embodiments, the wrapped software application 309 can also store information in a registry (e.g., store the activation key information that was embedded into the application 309 by the download manager 305 for later use when the key is needed). Some examples of data which can be inserted into the registry include string data (e.g., REG_SZ) and DWORD data (e.g., REG_DWORD). In some embodiments, there is also a root registry key, under which the parameters can be placed.

In some embodiments, the download manager 305 associates the licensing information with the software application 309 using a registration wrapper library that is incorporated into the download manager 305. The registration wrapper library is a software library enabling user applications to gain a generic wrapping functionality for executable files. The registration wrapper library can be incorporated into the download manager 305 components, thus giving the ability to the download manager 305 to wrap additional functionality into existing executables (e.g., a product's installation file—INSTALL.EXE). For example, in some embodiments, the download manager 305 uses the registration wrapper library to add automatic-activation functionality into the downloaded application's installers (e.g., WinRAR, InstallShield etc). The registration wrapper library is also useful to the download manager 305 in associating the licensing information with the application 309 where the application 309 is installed on a different computer than the one on which the download manager 305 is running.

In some embodiments, the registration wrapper library can store various parameters (e.g., the activation key) in a registry when the software application 309 is executed, and these parameters can include certain tokens in their path. Some examples of these tokens are the following:
% VID %—this token can be replaced with the Vendor ID
% PID %—this token can be replaced with the Product ID
% SID %—this token can be replaced with the Sku ID

In addition to the above, other tokens can be used (e.g., a token that contains the registry value name of one of the parameters). The tokens can be replaced by the actual values of the tokens. For example, if one of the arbitrary registry parameters stored a DWORD in a key value “PID,” then the token % PID % in the registry path would be replaced with a string representation of the DWORD value of the PID parameter.

Further customization of how the download manager 305 behaves can be specified by setting the arbitrary registry parameters to contain a combination of path and value. As one example, in controlling whether or not the download manager 305 creates a shortcut to itself, to the application 309, etc., a “Shortcut Creation Override” can be defined. In this example, the registry key could be specified as being “*download manager application shortcut override*.” The value of this parameter could be set to be a 2-digit binary number, where the first digit is a true/false representation of whether the download manager 305 application should create a shortcut to itself, and the second digit is a representation of whether the download manager 305 application should create a shortcut to the software application 309 once it has been downloaded. In this example, the value could be set to “00” to specify no shortcut creation at all, the value could be set to “11” to specify both shortcuts to be created, the value could be set to “10” to specify that only the shortcut to the download manager 305 application itself should be created, and not the one to the target file, and the value could be set to “01” to specify that only the shortcut to the target file should be created and not the shortcut to the download manager 305 itself. In this example, if this token is not specified as one of the parameters, the default behavior of the download manager 305 can be to create both the download manager 305 application shortcut and the software application 309 shortcut on the desktop.

In some embodiments, the vendor can request or specify a forced download location for the software application 309 (e.g., the vendor requests that the application 309 be installed on a particular drive). The vendor can do this by inserting tokens into the path specified to overcome issues associated with differing system drives, user folders, etc. In one example, if the vendor wished to save the licensing information to a folder called “my_folder” under the user's “My Documents” folder, the vendor could specify the following forced download location: “% my_doc %\myfolder.” Some other examples of tokens that can be inserted are listed below:
% sys_drive %—token can be replaced with the drive letter and colon for the drive that the system is installed on. For example “C:” if the system was installed on drive C:
% sys_dir %—token can be replaced with the system drive and folder where the user has installed Windows. For example “C:\Windows.”
% desktop %—token can be replaced with the drive and folder of the users desktop folder. For example “C:\Documents and Settings\user\Desktop.”
% my_doc %—token can be replaced with the drive and folder of the users “My Documents” folder. For example “C:Documents and Settings\user\My Documents.”
% user %—token can be replaced with the users home folder. For example “C:\Documents and Settings\user.”

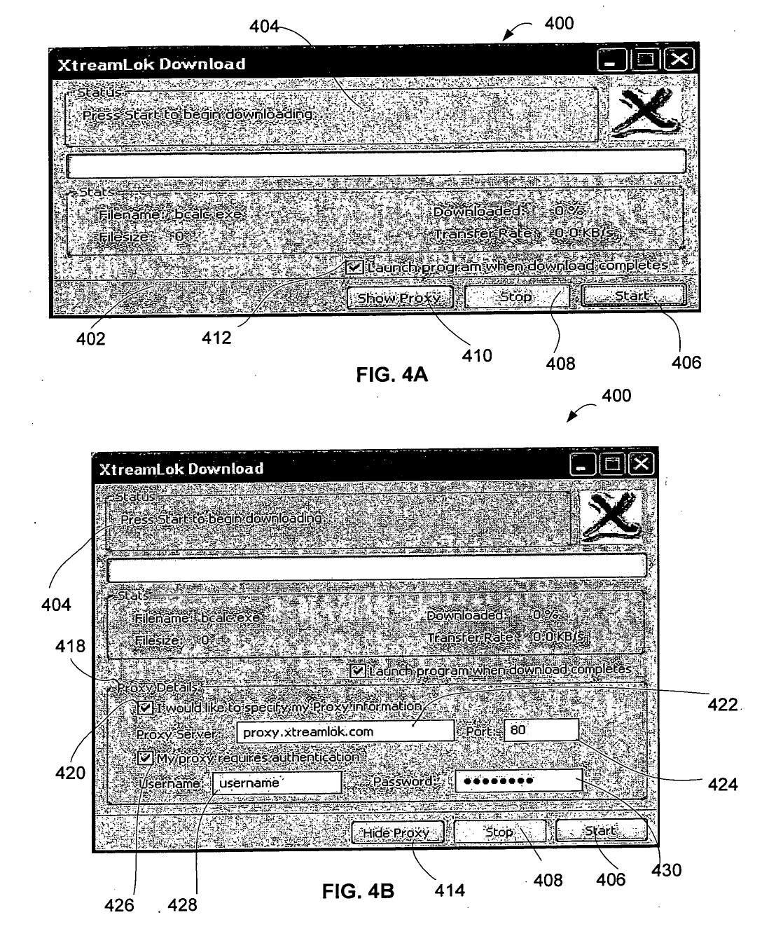

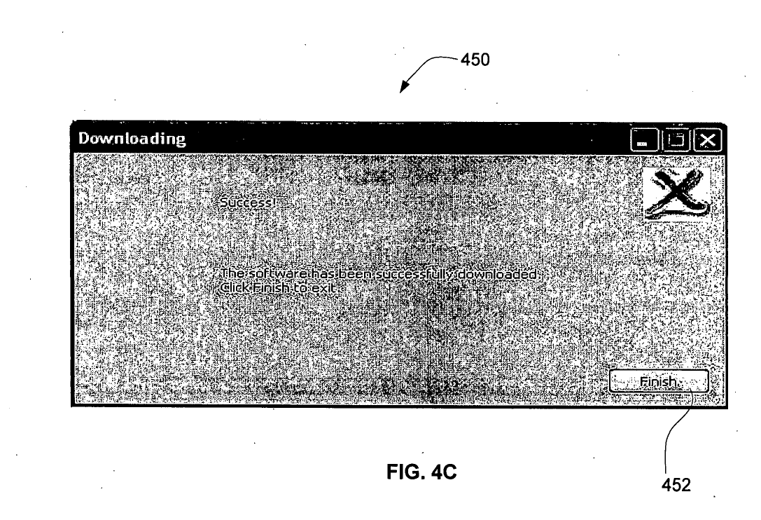

The customized download manager 305 can be configured in different manners and can include different types of user interfaces. FIGS. 4A, 4B, and 4C illustrate some examples of dialog boxes that can be used with the download manager 305, according to some embodiments. However, numerous different types of dialog boxes can be used and they can be designed in many different manners. In the examples of FIGS. 4A, 4B, and 4C, the download manager 305 includes two main user interface dialogs: 1) a main dialog 400 (FIGS. 4A and 4B), and 2) a finished dialog 450 (FIG. 4C). In addition to these main dialogs, the download manager 305 can also use standard message boxes (not shown) and save file dialogs (not shown). In some embodiments, the main dialog 400 has a control area 402 (e.g., an area including control buttons, checkboxes, etc. for the dialog box) and a user feedback area 404 (e.g., an area or field that provides information to the user). The control area 402 can include a number of different controls, such as the following:
1) Start button 406: This button can begin the process of downloading the file.
2) Stop button 408: This button can halt the download.
3) “Launch program . . . ” checkbox 412: This checkbox, if it is checked, can cause the downloaded file to automatically execute once the download is complete.
4) “Show Proxy” button 410: This button can expand the dialog to show Proxy Settings (see FIG. 4B showing the expanded dialog box with proxy setting choices visible).

The user feedback area 404 provides feedback and instructions to the user about numerous different issues. For example, the user feedback area 404 can provide information about the following:
How to begin the download
That the download manager 305 is connecting to a server
That the file is being downloaded
That the download manager 305 is disconnecting from the server
Progress of the download in the form of a progress bar and a percentage
Name of the file being downloaded
The file size of the file being downloaded
The current rate at which the file is being transferred

The dialog boxes illustrated in the examples shown in FIGS. 4A and 4B are similar except that in the dialog box shown in FIG. 4B, the Show Proxy Settings button 410 has been selected. Thus, FIG. 4B illustrates the expanded version of the dialog in FIG. 4A with the proxy details area 418 visible. The user can specify his proxy settings in this expanded area. For example, the user can click the “I would like to specify my Proxy information” checkbox 420 to select whether or not custom proxy settings are to be used at all. In this example, if this checkbox 420 is unchecked, the remaining controls are disabled, and when the download begins, the download manager 305 can use the user's default proxy settings. In this example, if the checkbox 420 is checked, two edit boxes below the checkbox 420 can become active. The “Proxy Server” edit field 422 and “Port” edit field 424 can allow a user to type in the address and connection port of the Proxy Server the user wishes to use. Also in this example, the “Login to Proxy server” checkbox 426 can enable a user to specify if he wishes to provide login details, which will be used to log in to the proxy server by the download manager 305. When this checkbox 426 is checked, the “Username” edit box 428 and the “Password” edit box 430 can become active and they can remain inactive when the checkbox 426 is unchecked. In addition, a Hide Proxy button 414 is shown in the example of FIG. 4B, which the user can select to collapse the proxy area down again and return to the format of the dialog box of FIG. 4A with the hidden proxy settings and the Show Proxy Settings button 410.

The final dialog 450 illustrated in the example of FIG. 4C can be used to convey a message to the user that the download has been successful. The user can click the “Finish” button 452, which can exit the download manager 305.

The examples of dialog boxes illustrated in FIGS. 4A, 4B, and 4C are but one example of how the user interface associated with the download manager 305 can be arranged. In other embodiments, one or more of these dialog boxes may not be used or may be replaced with other dialog boxes. In other embodiments, any one or more of the buttons, checkboxes, fields, areas, etc. shown in these example dialog boxes can be missing or modified or other buttons, checkboxes, fields, areas, etc. can be used or added.

Depending on the options used (e.g., options selected by the vendor) when creating the download manager 305, there may be some background requests sent by the download manager 305 which are invisible to the end user. These requests can be used to provide information about the download state of the software application 309. For example, a “Download Started” request can be sent when the user starts the download of the software application 309 for the first time (if the user stops and then resumes the download, this start message does not have to be re-sent). As another example, a “Download Completed” request can be sent when the download manager 305 has completed downloading the application 309. If the user hits “Stop” or the download is stopped in some other way, the Download Completed request is not sent. These two messages can also provide information to the vendor regarding the number of instances of the purchased application 309 not being completely downloaded.

As still another example, a “Download Percentage” request can be sent sporadically to the server 116 notifying the server 116 of the of the download completion percentage for a particular download manager 305 downloading a software application 309. This request can also be useful in overcoming issues with disconnection of a user from the Internet 112 by an Internet Service Provider (“ISP”) after an “idle” period. The download manager 305 can be designed to periodically send this request. The interval between requests can be set by the vendor or other entity when creating the download manager 305 to ensure that the ISP does not consider the Internet connection to be “idle.”

Referring to FIG. 3, the software application execution module 310 executes the software application 309. As described above, the licensing information associated with the software application 309 alters functionality of the executed software application 309. Once the customized download manager 305 downloads the software application 309, the application 309 can then be easily activated without manual intervention by the user (e.g., without requiring the user to insert an activation key into a field to unlock the application) since it is already associated with the relevant licensing information (e.g., the activation key information). The licensing information alters the functionality of the application 309 by allowing it to operate or be unlocked (or at least partially unlocked). In some embodiments, the licensing information alters the functionality by activating certain features of the software application that were previously inactivated. As described above, in some embodiments, the vendor may have even further included information that customizes the application 309 to the user (e.g., the Hello John Smith example), so the software application 309 can be customized to the user's needs, can greet the user, can provide other relevant information to the user, and the like. Thus, the licensing information can alter functionality of the application 309 by customizing it to the user (e.g., by modifying the user interface so that it is customized to the user to include a user-specific greeting, country specific information, etc.).

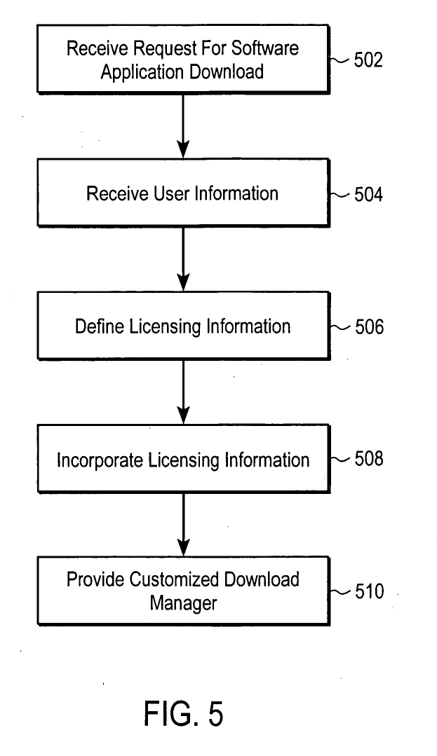

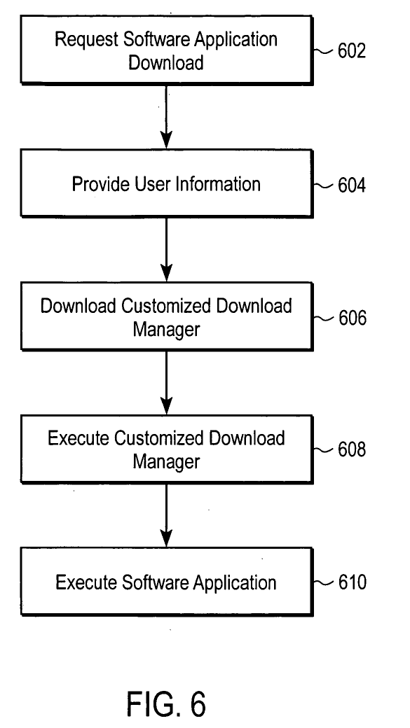

Referring now to FIG. 5, there is shown a flowchart illustrating the operation of the license control module 140 that is executed on the server 116, according to some embodiments of the present invention. It should be understood that these steps are illustrative only. Different embodiments of the license control module 140 may perform the illustrated steps in different orders, omit certain steps, and/or perform additional steps not shown in FIG. 5 (the same is true for FIG. 6).

As shown in FIG. 5, the license control module 140 receives 502 a request from a computer to download the software application 309. As described above, the module 140 can respond by prompting the user for information, and the module 140 thus receives 504 user information (e.g., purchase or personal information). The vendor can define 506 the licensing information that the vendor would like to be incorporated into the download manager. The vendor can define this in advance or at the time of the purchase. The vendor might specify that an activation key be included in the download manager and/or certain user-customization information. The module 140 incorporates 508 the licensing information into a download manager to generate a customized download manager 305 that is specific to the download request. In some embodiments, the module 140 modifies a generic download manager application by embedding into it the vendor-defined licensing information.

The module 140 provides 510 the customized download manager generated to the computer 110. The customized download manager 305 is executed on the computer 110 and the download manager 305 in turn downloads the software application 309 onto the computer 110. In addition, the customized download manager 305 associates the licensing information with the software application 309. These steps are illustrated and described in reference to FIG. 6, below.

Referring now to FIG. 6, there is shown a flowchart illustrating the operation of the license control module 120 that is executed on the client 110, according to some embodiments of the present invention. The module 120 sends a request 602 to the server 116 to download a software application 309. The user can access the vendor's website and click on a link or take some other action to make the download request. The user can provide 604 user information (e.g., personal information, credit card information, etc.) to the server 116 (e.g., by inserting the information into fields on the website, by responding to a prompt, etc.). The user can then complete the download request and the module 120 can download 606 a customized download manager onto the computer 110. As described above, the customized download manager incorporates licensing information provided by the vendor that is specific to the download request.

The module 140 executes the customized download manager 305 on the computer 110. The customized download manager 305 in turn downloads the software application 309 onto the computer and associates the licensing information with the software application 309. In some embodiments, the download manager 305 associates 510 the licensing information with the application 309 by wrapping the application 309 with the information, by modifying the file, and the like. In other embodiments, the download manager 305 associates 510 the information with the application 309 by placing the information in a registry to which the software application 309 has access.

The module then executes 610 the downloaded software application 309. The licensing information associated with the software application can alter functionality of the executed software application. For example, the information can permit the software application 309 to operate or to operate properly by acting as an activation key that unlocks the application 309 or certain features of the application 309. As another example, the information can alter the functionality of the application 309 by customizing it to the user so certain greetings appear to the user, so the user interface is designed specific to the user, so particular windows pop up to the user, and so forth. In some embodiments, the software application 309 is executed on a different computer 110 than the one on which the download manager was executed. In other embodiments, the software application 309 and download manager 305 are both downloaded onto and executed on the same computer 110.

As will be understood by those familiar with the art, the invention may be embodied in other specific forms without departing from the spirit or essential characteristics thereof. Likewise, the particular naming and division of the modules, managers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

We claim:

1. A computer program product having a computer-readable medium having computer program instructions recorded thereon for managing downloading of a software application and associating the software application with licensing information, the computer program instruction comprising instructions for:
receiving a request from a computer to download the software application;
incorporating the licensing information into a download manager to generate a customized download manager that is specific to the download request; and
providing the customized download manager to the computer, wherein the customized download manager is executed on the computer and downloads the software application onto the computer, the customized download manager associating the licensing information with the software application, the licensing information altering functionality of the software application when executed.

2. The computer program product of claim 1, wherein the licensing information is an activation key and wherein altering the functionality of the executed software application further comprises applying the activation key to permit the software application to operate.

3. The computer program product of claim 1, wherein the licensing information comprises user-customization information and wherein altering the functionality of the executed software application further comprises applying user-customization information to customize a user interface for the software application.

4. The computer program product of claim 1, wherein the customized download manager associates licensing information with the software application by modifying the software application to insert the licensing information into the application.

5. The computer program product of claim 1, wherein the customized download manager associates licensing information with the software application by placing the licensing information in a registry.

6. The computer program product of claim 1, wherein the software application is executed on a computer that is different from the computer on which the customized download manager is executed.

7. A method of managing downloading of a software application and associating the software application with licensing information, the method comprising:
receiving a request from a computer to download the software application;
incorporating the licensing information into a download manager to generate a customized download manager that is specific to the download request; and
providing the customized download manager to the computer, wherein the customized download manager is executed on the computer and downloads the software application onto the computer, the customized download manager associating the licensing information with the software application, the licensing information altering functionality of the software application when executed.

8. The method of claim 7, wherein the licensing information is an activation key and wherein altering the functionality of the executed software application further comprises applying the activation key to permit the software application to operate.

9. The method of claim 7, wherein the licensing information comprises user-customization information and wherein altering the functionality of the executed software application further comprises applying user-customization information to customize a user interface for the software application.

10. The method of claim 7, wherein the customized download manager associates licensing information with the software application by modifying the software application to insert the licensing information into the application.

11. The method of claim 7, wherein the customized download manager associates licensing information with the software application by placing the licensing information in a registry.

12. The method of claim 7, wherein the software application is executed on a computer that is different from the computer on which the customized download manager is executed.

13. A system for managing downloading of a software application and associating the software application with licensing information, the system comprising:
a receiving module for receiving a request from a computer to download the software application;
an incorporation module for incorporating the licensing information into a download manager to generate a customized download manager that is specific to the download request; and
a download manager delivery module for providing the customized download manager to the computer, wherein the customized download manager is executed on the computer and downloads the software application onto the computer, the customized download manager associating the licensing information with the software application, the licensing information altering functionality of the software application when executed.

14. The system of claim 13, wherein the licensing information comprises an activation key that is configured for altering the functionality by permitting the software application to operate.

15. The system of claim 13, wherein the licensing information comprises user-customization information for altering the functionality by customizing a user interface for the software application.

16. The system of claim 13, wherein the customized download manager is further configured for modifying the software application to insert the licensing information into the application.

17. The system of claim 13, wherein the customized download manager is further configured for placing the licensing information in a registry.

18. The system of claim 13, wherein the software application is executed on a computer that is different from the computer on which the customized download manager is executed.

19. A system for managing downloading of a software application and associating the software application with licensing information, the system comprising:
means for receiving a request from a computer to download the software application;
means for incorporating the licensing information into a download manager to generate a customized download manager that is specific to the download request; and
means for providing the customized download manager to the computer, wherein the customized download manager is executed on the computer and downloads the software application onto the computer, the customized download manager associating the licensing information with the software application, the licensing information altering functionality of the software application when executed.

20. The system of claim 19, wherein the licensing information comprises an activation key that is configured for altering the functionality by permitting the software application to operate.

21. A computer program product having a computer-readable medium having computer program instructions recorded thereon for downloading of a software application, the computer program instruction comprising instructions for:
making a download request to download the software application from a server;
downloading a customized download manager onto a computer, the customized download manager incorporating licensing information provided by a software vendor that is specific to the download request;
executing the customized download manager on the computer, wherein the customized download manager downloads the software application onto the computer and associates the licensing information with the software application; and
executing the software application, wherein the licensing information associated with the software application alters functionality of the executed software application.

22. The computer program product of claim 21, wherein the licensing information is an activation key and wherein altering the functionality of the executed software application further comprises applying the activation key to permit the software application to operate.

23. The computer program product of claim 21, wherein the licensing information comprises user-customization information and wherein altering the functionality of the executed software application further comprises applying user-customization information to customize a user interface for the software application.

24. The computer program product of claim 21, wherein the customized download manager associates licensing information with the software application by modifying the software application to insert the licensing information into the application.

25. The computer program product of claim 21, wherein the customized download manager associates licensing information with the software application by placing the licensing information in a registry.

26. The computer program product of claim 21, further comprising executing the software application on a computer that is different from the computer on which the customized download manager is executed.

27. A method for downloading of a software application, the method comprising:
making a request to download the software application from a server;
downloading a customized download manager onto a computer, the customized download manager incorporating licensing information provided by a software vendor that is specific to the download request;
executing the customized download manager on the computer, wherein the customized download manager downloads the software application onto the computer and associates the licensing information with the software application; and
executing the software application, wherein the licensing information associated with the software application alters functionality of the executed software application.

28. The method of claim 27, wherein the licensing information is an activation key and wherein altering the functionality of the executed software application further comprises applying the activation key to permit the software application to operate.

29. The method of claim 27, wherein the licensing information comprises user-customization information and wherein altering the functionality of the executed software application further comprises applying user-customization information to customize a user interface for the software application.

30. The method of claim 27, wherein the customized download manager associates licensing information with the software application by modifying the software application to insert the licensing information into the application.

31. The method of claim 27, wherein the customized download manager associates licensing information with the software application by placing the licensing information in a registry.

32. The method of claim 27, further comprising executing the software application on a computer that is different from the computer on which the customized download manager is executed.

33. A system for downloading of a software application, the system comprising:
a request module for making a request to download the software application from a server;
a download module for downloading a customized download manager onto a computer, the customized download manager incorporating licensing information provided by a software vendor that is specific to the download request;
a download manager execution module for executing the customized download manager on the computer, wherein the customized download manager downloads the software application onto the computer and associates the licensing information with the software application; and
a software application execution module for executing the software application, wherein the licensing information associated with the software application alters functionality of the executed software application.

34. The system of claim 33, wherein the licensing information comprises an activation key that is configured for altering the functionality by permitting the software application to operate.

35. The system of claim 33, wherein the licensing information comprises user-customization information for altering the functionality by customizing a user interface for the software application.

36. The system of claim 33, wherein the customized download manager is further configured for modifying the software application to insert the licensing information into the application.

37. The system of claim 33, wherein the customized download manager is further configured for placing the licensing information in a registry.

38. The system of claim 33, wherein the software application is executed on a computer that is different from the computer on which the customized download manager is executed.

39. A system for downloading of a software application, the system comprising:
means for making a request to download the software application from a server;
means for downloading a customized download manager onto a computer, the customized download manager incorporating licensing information provided by a software vendor that is specific to the download request;
means for executing the customized download manager on the computer, wherein the customized download manager downloads the software application onto the computer and associates the licensing information with the software application; and
means for executing the software application, wherein the licensing information associated with the software application alters functionality of the executed software application.

40. The system of claim 39, wherein the licensing information comprises an activation key that is configured for altering the functionality by permitting the software application to operate.
